(19) United States
(12) Patent Application Publication
(10) Pub. No.: US 2025/0153199 A1
(43) Pub. Date: May 15, 2025

(54) PRESSURIZED SHOWERHEAD HAVING AN ARRAY OF DIGITALLY CONTROLLED VALVES

(71) Applicant: KOHLER CO., Kohler, WI (US)

(72) Inventors: Pete Kajuch, Brookfield, WI (US); Jesse Miller, Fond du Lac, WI (US)

(73) Assignee: KOHLER CO., Kohler, WI (US)

(21) Appl. No.: 18/927,092

(22) Filed: Oct. 25, 2024

Related U.S. Application Data
(60) Provisional application No. 63/599,046, filed on Nov. 15, 2023.

(51) Int. Cl. B05B 1/18

(52) U.S. Cl. CPC B05B 1/18

(57) ABSTRACT

A pressurized showerhead assembly for generating various spray sequences includes a housing, a water distribution line, and a plurality of electronically controlled valves. The housing defines an interior cavity and a spray face. The spray face defines a plurality of openings. The water distribution line is disposed within the interior cavity. The valves are disposed within the interior cavity and are fluidly coupled to the water distribution line. The valves are distributed across the interior cavity and are configured to control a flow of water passing through the plurality of openings.

### CROSS-REFERENCE TO RELATED APPLICATIONS

This application claims the benefit of and priority to U.S. Provisional Application No. 63/599,046, filed Nov. 15, 2023, the entire contents of which are hereby incorporated by reference herein.

### BACKGROUND

The present disclosure relates generally to water delivery devices, such as showerhead assemblies. More specifically, the present disclosure relates to showerhead assemblies that can create spray experiences. The spray experiences may be functional spray experiences (e.g., massage, mist, rain, etc.) or visual imagery experiences from water droplets.

Some large-scale devices can produce visual imagery using water droplets to provide aesthetic displays (e.g., Graphical Waterfall®, etc.). These devices can provide unique patterns, textual messages, or other imagery by controlling water flow from individual spray outlets. These devices are typically built with large industrial valves and use a large volume of water that may be recirculated in a closed loop. However, this large-scale construction is not suitable for a consumer shower environment. Additionally, improvements to these designs would be useful to increase efficiency of water usage and to increase the variety of the spray experiences that can be produced.

### SUMMARY

One embodiment of the present disclosure relates to a showerhead assembly including a housing, a water distribution line, and a plurality of electronically controlled valves. The housing defines an interior cavity and a spray face. The spray face defines a plurality of openings. The water distribution line is disposed within the interior cavity. The valves are disposed within the interior cavity and are fluidly coupled to the water distribution line. The valves are distributed across the interior cavity and are configured to control a flow of water passing through the plurality of openings.

In some embodiments, the plurality of electronically controlled valves are normally-open directing acting valves. In some embodiments, the showerhead assembly includes a control system that is communicably coupled to the plurality of electronically controlled valves, and that is configured to control the valves using pulse-width modulation (PWM) techniques, which can improve the overall user experience.

Another embodiment of the present disclosure relates to a showerhead assembly including a housing and a plurality of valve assemblies. The housing defines an interior cavity and a spray face. The spray face defines a plurality of openings. The plurality of valve assemblies are coupled to the housing. At least one valve assembly of the plurality of valve assemblies includes a plurality of electronically controlled valves, a flow splitter, and a distributor. The plurality of electronically controlled valves are configured to control a flow of water passing through the plurality of openings. The flow splitter is coupled to the plurality of electronically controlled valves and is configured to distribute flow between the plurality of electronically controlled valves. The distributor is coupled to at least one of the plurality of electronically controlled valves and engages at least one opening of the plurality of openings.

Yet another embodiment of the present disclosure relates to a control system for a showerhead assembly. The control system includes a plurality of electronically controlled valves; a user interface; and a controller communicably coupled to the plurality of electronically controlled valves and the user interface. The controller is configured to receive a user input from the user interface inclusive of a plurality of spray parameters associated with a form of a spray pattern that is observable by a user of a showerhead assembly. The controller is also configured to determine a plurality of pulse width modulation (PWM) parameters for the plurality of electronically controlled valves based on the plurality of spray parameters. The controller is further configured to control the plurality of electronically controlled valves based on the plurality of PWM parameters.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a front perspective view of a showerhead assembly, according to an embodiment;

FIG. 2 is a rear perspective view of the showerhead assembly of FIG. 1;

FIG. 3 is a rear perspective view of an interior view of the showerhead assembly of FIG. 1, shown with a portion of the housing and a plurality of valve assemblies removed from the showerhead assembly;

FIG. 4 is a rear perspective view of another interior view of the showerhead assembly of FIG. 1, shown with a portion of the housing removed from the showerhead assembly;

FIG. 5 is a partially exploded view of the showerhead assembly of FIG. 1;

FIG. 6 is a side cross-sectional view through a valve assembly of the showerhead assembly of FIG. 1;

FIG. 7 is a side cross-sectional view through a cage of a single valve assembly of the showerhead assembly of FIG. 1;

FIG. 8 is a side perspective cross-sectional view of a distributor of the valve assembly of FIG. 7;

FIG. 9 is a block diagram of a control system that can be used with the showerhead assembly of FIG. 1;

FIG. 10 is a flow diagram of a method of generating a spray sequency for a showerhead assembly that includes a plurality of electronically controlled valves;

FIG. 11A is a wireframe diagram of a graphical user interface that can be implemented by the control system of FIG. 9;

FIG. 11B is a wireframe diagram of an indicator structure that can be implemented as part of the graphical user interface of FIG. 11 for selecting different spray sequences;

FIG. 12A is a graphical user interface for a control system of a showerhead, according to another embodiment;

FIG. 12B is a reproduction of the graphical user interface of FIG. 12A shown with a graphical solenoid grid hidden from view;

FIG. 12C is a reproduction of the graphical user interface of FIG. 12A showing a safe exit dropdown option;

FIG. 12D is a reproduction of the graphical user interface of FIG. 12A showing view options for the graphical user interface; and

FIG. 12E is a reproduction of the graphical user interface of FIG. 12A showing a utilities/settings dropdown for the graphical user interface.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a pressurized rain shower style showerhead assembly is shown that produces personalized spray experiences using water supplied at residential water pressures and flow rates. The showerhead assembly includes an array of electronically controlled valves that enable changing the shape or location of water delivery in any desired pattern and sequence. In at least one embodiment, the showerhead assembly provides a programmable spray experience that can be remotely controlled by a digital user interface, such as a smartphone. The spray experience can be programmed with infinite water pattern designs using pulse width modulation (PWM) techniques to create a unique showering experience for each user, while still complying with residential plumbing codes.

In at least one embodiment, the showerhead assembly includes a housing and a pressurized water distribution line disposed within the housing. The water distribution line is configured to receive and distribute water to each valve within the showerhead during operation. The water distribution line is configured to operate at elevated pressures that would be challenging to achieve in an open plenum showerhead design. In some embodiments, the water distribution line includes multiple supply conduits between an inlet of the showerhead assembly and the valves, and bridge connections that fluidly couple adjacent ones of the plurality of supply conduits. Such an arrangement can improve flow uniformity across the showerhead assembly, which can improve consistency in spray characteristics generated by different valves. In some embodiments, the valves are normally-open solenoid valves, which allow for continued operation of the showerhead with the controller switched off and can provide a failsafe that prevents over pressurization of the nozzles/spray face during loss of power.

The showerhead assembly also includes a control system that is configured to control operations of the valves to generate different spray patterns in response to user inputs. In some embodiments, the control system is configured to determine operating parameters of the PWM valves based on inputs that are easier for a user to understand. For example, the control system may be configured to determine an operating frequency and duty cycle of the PWM valves based on spray parameters such as water droplet size or stream length, time between successive water droplets or streams emitted by the showerhead assembly, flow intensity, and the like.

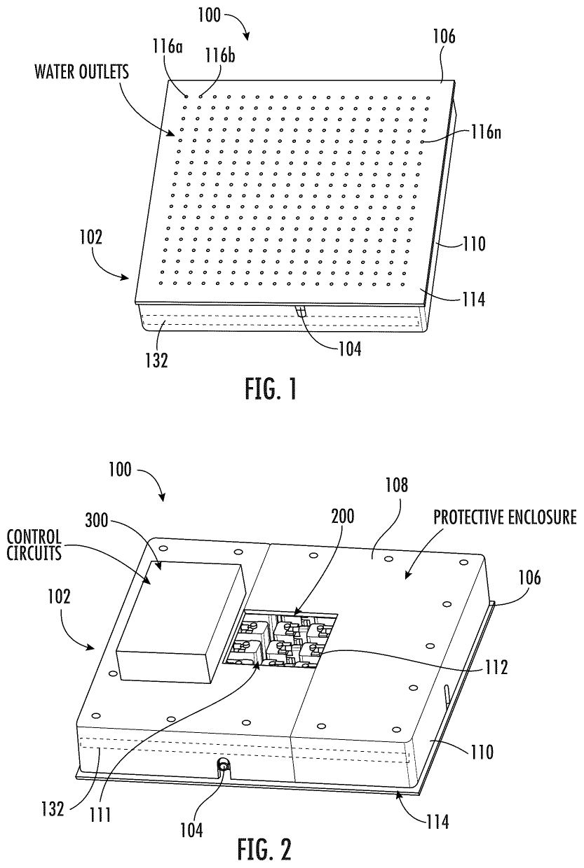

Referring to FIGS. 1 and 2, a showerhead assembly 100 is shown, according to an embodiment. The showerhead assembly 100 is configured to produce a spray experience that is user-adjustable, and is configured to generate patterns, images, and/or any desired spray sequence based on user inputs. The showerhead assembly 100 includes a housing 102, a water distribution line 104, a plurality of valve assemblies 200, and a control system 300. In other embodiments, the showerhead assembly 100 may include additional, fewer, and/or different components.

The housing 102 includes a front plate 106 (e.g., a bottom plate when installed in a shower enclosure, a spray plate, a spray panel, a faceplate, etc.), a rear plate 108 (a top plate when installed in a shower enclosure), and a plurality of sidewalls 110 extending between the front plate 106 and the rear plate 108. In some embodiments, the rear plate 108 and the sidewalls 110 are integrally formed as a single monolithic body from a single piece of material. In such embodiments, the rear plate 108 and the sidewalls 110 together define a rear housing cover of the housing 102. Integrating the sidewalls 110 with the rear plate 108 can simplify assembly and servicing in some embodiments, by providing greater access to the water distribution line 104 when the rear plate 108 is separated from the rest of the housing 102. In other embodiments, the sidewalls 110 are integrally formed with the front plate 106 instead of the rear plate 108.

The front plate 106, the rear plate 108, and the sidewalls 110 together define an interior cavity 111. The interior cavity 111 is sized to receive the water distribution line 104 and the valve assemblies 200 therein.

In some embodiments, an outer dimension between opposing sidewalls 110 is less than an outer dimension of the front plate 106. Such embodiments can facilitate mounting of the showerhead assembly so that the front plate 106 is approximately flush with a wall defining a portion of the shower enclosure (e.g., an upper wall, a ceiling, etc.), thereby providing a more pleasing aesthetic to a user. In other embodiments, the sidewalls 110 may protrude away from the wall defining a portion of the shower enclosure and into the shower enclosure as will be further described.

Referring to FIG. 2, the rear plate 108 defines an access opening 112 that is configured to receive wires (e.g., a wire harness, etc.) therethrough to electrically couple the plurality of valve assemblies 200 to the control system 300. The access opening 112 may be of any shape and size depending on application requirements. In the embodiment of FIG. 1, the access opening 112 is a rectangular through hole opening that is centrally located along the rear plate 108.

The front plate 106 defines a spray face 114 from which water is distributed from the showerhead assembly 100. The spray face 114 defines a plurality of openings 116a-116n (collectively, openings 116) extending through the front plate 106. In at least one embodiment, the plurality of openings 116 are nozzle openings that are configured to deliver water from the valve assemblies 200 (e.g., nozzles of the distributors of the valve assemblies 200, etc.) into a shower enclosure. In some embodiments, the openings 116 are distributed in equal intervals across the spray face 114. However, it should be understood that the number and arrangement of the openings 116 may be different in various embodiments. In the embodiment of FIG. 1, the openings 116 are distributed in a rectangular array having a plurality of aligned columns and rows of openings.

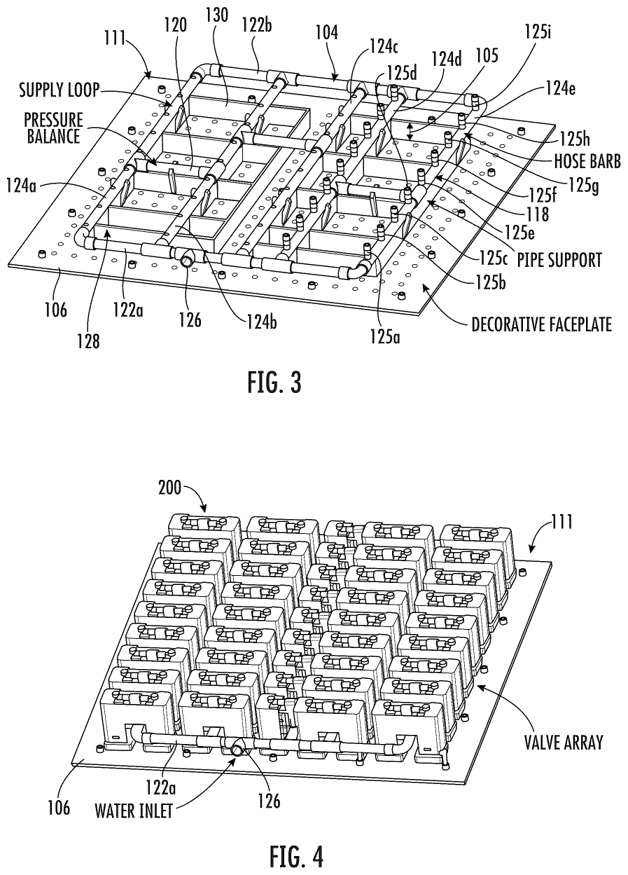

Referring to FIG. 3, the water distribution line 104 is configured to receive water at residential water supply pressures and to deliver the pressurized water to the individual valve assemblies 200. In the embodiment of FIG. 3, the water distribution line 104 is a pressurized water distribution line that is configured to be fluidly coupled (e.g., directly) to a residential water supply line providing water at residential water supply pressures. As used herein, “residential water supply pressures” and similar terms may refer to water pressures between approximately 45 PSI and 80 PSI. Stated differently, the water distribution line 104 is configured to continuously supply a source of water at residential water pressures to the valve assemblies 200 and to prevent the interior cavity 111 from becoming exposed to water at elevated pressure. Such an arrangement can reduce the amount of time required for delivery of water from the showerhead assembly 100 when the valves are switched on. Such an arrangement can also increase the structural reliability of the showerhead assembly 100 as compared to an open fluid plenum design by eliminating the need to design the front plate 106 to withstand exposure to water at elevated pressure across its face. The water supply and distribution arrangements of the present disclosure can also enable the use of larger spray face designs that would otherwise be limited by the pressure drop across the spray face.

The water distribution line 104 extends across the front plate 106 within the interior cavity 111. The water distribution line 104 is an enclosed fluid conduit that extends from an inlet 126 of the showerhead assembly 100 to each one of the plurality of valve assemblies 200. The water distribution line 104 includes one or more water supply loops including an outer perimeter loop and a plurality of inner loops that extend inwardly from the outer perimeter loop. In some embodiments, the water distribution line 104 includes a plurality of supply conduits 118 and a plurality of bridge connections 120 that fluidly couple adjacent ones of the plurality of supply conduits 118.

The plurality of supply conduits 118 and the plurality of bridge connections 120 are disposed within the interior cavity 111. In some embodiments, the plurality of supply conduits 118 are pipes extending within the interior cavity 111. In at least one embodiment, the plurality of supply conduits 118 includes at least one lateral conduit 122a-122b (collectively, lateral conduits 122) and a plurality of longitudinal conduits 124a-124e (collectively, longitudinal conduits 124) extending away from the lateral conduit(s) 122. Referring still to FIG. 3, the lateral conduit(s) 122 is coupled to the inlet 126 of the water distribution line 104 and extends away from the inlet 126 in a substantially perpendicular orientation relative to a central axis of the inlet 126. The longitudinal conduits 124 extend away from the lateral conduit(s) 122 in a substantially perpendicular orientation relative to the lateral conduit(s) 122. In the embodiment of FIG. 3, the water distribution line 104 includes a pair of diametrically opposed lateral conduits 122 that are disposed on opposing axial ends of the plurality of longitudinal conduits 124.

In at least one embodiment, the inlet 126 of the water distribution line 104 is disposed proximate to a central position along the at least one lateral conduit 122. Such an arrangement can reduce the pressure drop between the inlet 126 and opposing ends of the lateral conduit(s) 122, which can improve flow uniformity of water across the showerhead assembly relative to a design in which water is introduced directly into the interior cavity 111 of the housing 102. Such an approach can provide a uniform spray pattern (e.g., flow rates, etc.) across the spray face 114 for water consumption rates of 2.5 gallons per minute, 2.0 gallons per minute, or less.

In some embodiments, the longitudinal conduits 124 are arranged in an array of substantially parallel rows or columns. Each of the longitudinal conduits 124 is a substantially linear conduit that extends across the interior cavity 111 and is configured to supply water to at least one row of valve assemblies 200 (e.g., one row of openings 116 that extend across the front plate 106). It should be appreciated that the shape and/or number of longitudinal conduits 124, and/or the spacing between adjacent ones of the longitudinal conduits 124 may be different in various embodiments. Additionally, the angles between the lateral conduit(s) 122 and the longitudinal conduits 124 may also differ in various embodiments.

Each of the longitudinal conduits 124 includes a plurality of fluid connections 125a-125i (collectively, fluid connections 125) that are configured to couple the water distribution line 104 to the valve assemblies 200. In some embodiments, the plurality of fluid connections 125 includes hose barbs that extend radially away from the longitudinal conduits 124 (and away from the front plate 106 in a direction that is substantially perpendicular to the front plat 106). In other embodiments, another type of fluid connection 125 may be used, such as a push-to-connect fitting or another type of quick-connect, fluid-tight fitting.

The bridge connections 120 are pressure balance connections that are configured to maintain uniform pressure across the water distribution line 104. The bridge connections 120 include crossflow conduits that extend laterally between adjacent ones of the longitudinal conduits 124. The bridge connections 120 are positioned to maintain similar conduit lengths of the conduit used for the water distribution line 104 between the inlet 126 and each individual valve assembly 200. In the embodiment of FIG. 3, the bridge connections 120 are disposed at a central position along the longitudinal conduits 124, approximately equidistant from each one of the pair of lateral conduits 122. In some embodiments, the bridge connections 120 are staggered along the length of at least one of the longitudinal conduits 124.

The plurality of supply conduits 118 and the plurality of bridge connections 120 may be formed from copper tubing or another type of residential water supply pipe. In some embodiments, the bridge connections 120 are formed from a similar tubing size as the plurality of supply conduits 118. In other embodiments, the relative size of at least one of the bridge connections 120, the lateral conduit(s) 122, and/or the longitudinal conduits 124 may be different from one another.

Referring still to FIG. 3, the showerhead assembly 100 may further include a support structure 128 disposed within the interior cavity 111. The support structure 128 is configured to elevate (e.g., suspend, etc.) the water distribution line 104 within the interior cavity 111. The water distribution line 104 is suspended within the interior cavity 111 and above the front plate 106. The support structure 128 supports the water distribution line 104 a distance 105 apart from the front plate 106. In some embodiments, the support structure 128 is a framework 130 that extends across the front plate 106 and along areas of the front plate 106 that are between rows and/or columns of the plurality of openings 116. The framework 130 includes a plurality of elongated panels that extend away from the front plate 106 in a substantially perpendicular orientation relative to the front plate 106. The elongated panels may be welded or otherwise coupled to the front plate 106. In other embodiments, the elongated panels may be integrally formed with the front plate 106 as a monolithic body from a single piece of material. In other embodiments, the support structure 128 is a separate component(s) from the front plate 106 that rests on the front plate but is not coupled thereto.

In the embodiment of FIG. 3, the framework 130 also includes a plurality of connectors (e.g., snap-fit connectors, etc.) that clip, snap, or otherwise couple the elongated panels to the water distribution line 104, and allow for removal of the water distribution line 104 during servicing. The water distribution line 104 is spaced apart from the front plate 106 by the framework 130, which provides space for fitment between the valve assemblies 200, as will be further described.

Referring to FIG. 4, the valve assemblies 200 are arranged in an array of columns and/or rows that extend across the front plate 106, and across the portion of the front plate 106 that defines the plurality of openings 116. The valve assemblies 200 are configured to control the spray patterns produced by the showerhead assembly 100.

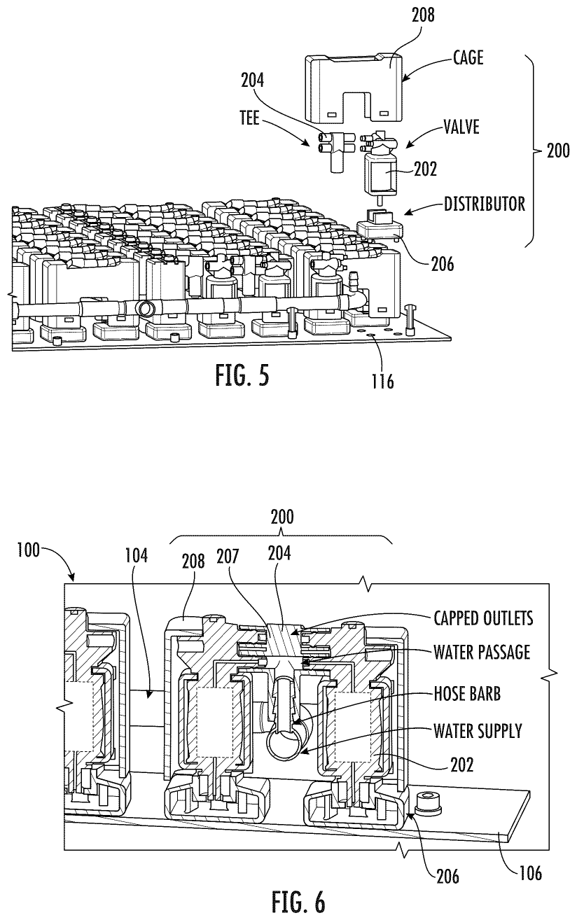

Referring to FIG. 5, the valve assemblies 200 are self-contained units that are designed to facilitate servicing of individual valves and to improve the overall structural integrity of the showerhead assembly 100. At least one of the plurality of valve assemblies 200 includes a plurality of electronically controlled valves 202, a flow distribution member 204, a distributor 206, and a cage 208. In other embodiments, the valve assemblies 200 may include additional, fewer, and/or different components.

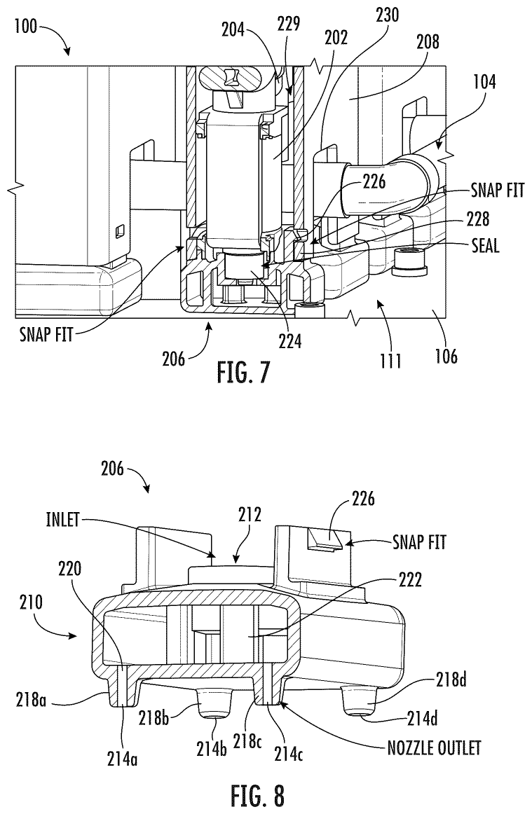

Referring to FIGS. 6 and 7, various cross-sectional views through one of the valve assemblies 200 is shown. Each of plurality of electronically controlled valves 202 is configured to control the flow of water passing through at least one of the plurality of openings 116. In the embodiment of FIGS. 6 and 7, each of the plurality of electronically controlled valves 202 is configured to control the flow of water passing through four adjacent openings along the front plate 106, as will be further described.

According to various embodiments, the electronically controlled valves 202 are direct acting solenoid valves. In at least one embodiment, the electronically controlled valves 202 are configured to be controlled using pulse-width modulation (PWM) techniques that allow for independent control of a duty cycle and an operating frequency of the valves. The use of PWM control techniques in the showerhead assembly 100 increases the number and variety of spray patterns (e.g., images, shapes, effects, etc.) that can be produced, and can enable generation of almost any conceivable spray sequence for the purpose of specific showering functions such as rinsing, warming, a message, and/or simply to produce aesthetically pleasing spray pattern sequences. In at least one embodiment, the electronically controlled valves 202 are normally-open valves that close when energized. Such an arrangement can allow for continued flow of water through the showerhead assembly 100 when the control system (e.g., the controller) is switched off, and also provides a failsafe that prevents over pressurization of components of the showerhead assembly 100 during loss of power. In the embodiment of FIGS. 6 and 7, at least one valve assembly 200 includes a pair of electronically controlled valves 202.

The flow distribution member 204 is configured to fluidly couple each valve of the valve assembly 200 to the water distribution line 104 so that each pair of electronically controlled valves 202 shares a single connection to the water distribution line 104. The flow distribution member 204 includes a fluid fitting. In the embodiment of FIGS. 6 and 7, the flow distribution member 204 includes a flow splitter, shown as Tee fitting 207 that is configured to fluidly couple the pair of valves of the valve assembly 200 to a respective one of the hose barbs along the flow distribution member 204. The flow splitter is configured to distribute flow approximately uniformly between the pair of valves. In other embodiments, the flow distribution member 204 may include another type of fluid fitting or fluid coupler. For example, the flow distribution member 204 may enable a face mount valve configuration in which each valve is coupled to a surface/face of a fluid transfer block defining passages that fluidly couple at least one valve to at least one of the water distribution line 204 or the distributor 206.

The distributor 206 is coupled to at least one of the plurality of electronically controlled valves 202 and engages (e.g., extends into and/or through, etc.) at least one of the plurality of openings 116. The distributor 206 is configured to direct water from a respective one of the pair of electronically controlled valves 202 to and/or through at least one of the plurality of openings 116. In some embodiments, the distributor 206 engages and fluidly couples the electronically controlled valve 202 to at least two of the plurality of openings 116. In the embodiment of FIGS. 6 and 7, the distributor 206 fluidly couples the electronically controlled valve 202 to four adjacent openings along the front plate 106 that are arranged in a rectangular shape (e.g., a square shape). In such embodiments, the spray pattern and flow rate of water leaving each of the four adjacent openings is approximately the same. Such an arrangement can reduce the overall number of valves required for the showerhead assembly 100, while maintaining sufficient spatial resolution of the spray patterns produced. For example, the distributor 206 may be designed to provide spray control within a spatial resolution of approximately 1.0 in.×1.0 in., 1.5 in.×1.5 in, 2.0 in.×2.0 in., or any range between and including the foregoing values. Such spatial resolution can simulate a near continuous (as opposed to step-wise) variation in flow patterns across the showerhead assembly 100 during operation. In other embodiments, the spatial resolution may be different. It should be understood that the distributor 206 may fluidly couple the electronically controlled valve 202 to a greater or fewer number of openings along the front plate 106 in other embodiments.

Referring to FIG. 8, a distributor 206 is shown that can be used in the valve assembly 200 described with reference to FIGS. 6 and 7. For simplicity, the same numbering will be used to identify similar components.

The distributor 206 includes a distributor body 210 defining a distributor inlet 212, a plurality of distributor outlets 214, and a flow distribution cavity 216 therein. The flow distribution cavity 216 fluidly couples the distributor inlet 212 to the plurality of distributor outlets 214a-214b (collectively, distributor outlets 214. The distributor 206 also includes a plurality of protrusions 218a-218d (collectively, protrusions 218) that are engageable with respective ones of the plurality of openings 116 on the front plate 106 (see also FIG. 7). In at least one embodiment, the protrusions 218 define nozzles of the showerhead assembly 100. In some embodiments, and as shown, the protrusions 218 are cylindrical studs that extend away from a distal wall (e.g., a lower wall as shown in FIG. 8, etc.) of the distributor body 210. Each of the protrusions 218 defines a flow channel 220 extending axially therethrough and defining a respective one of the plurality of distributor outlets 214. In some embodiments, the protrusions 218 defining the flow channel(s) 220 can be elastomeric (e.g., made from an elastomeric material, such as rubber, etc.) such that deposits which may form obstructions to water flow may be easily cleaned.

The distributor 206 also includes a plurality of support elements 222 disposed circumferentially around the distributor inlet 212 and extending axially between a proximal wall (e.g., and upper wall as shown in FIG. 8) and the distal wall of the distributor body 210. The support elements 222 can increase the strength of the distributor body 210 under hydraulic forces generated by pressurized operation.

The distributor inlet 212 is sized to receive an outlet connector of a respective one of the pair of electronically controlled valves 202 therein. Referring again to FIG. 7, in some embodiments, the distributor 206 forms part of a distributor assembly that includes a seal member 224. The seal member 224 is disposed within the distributor inlet 212 and is configured to sealingly engage the valve 202 with the distributor 206.

In some embodiments, the distributor 206 is configured to couple to the cage 208 to secure the valve assembly 200 in position within the interior cavity 111. In the embodiments of FIGS. 7 and 8, the distributor body 210 includes a plurality of clips 226 extending axially away from the proximal wall of the distributor body 210 on opposing sides of the distributor inlet 212. The clips 226 are engageable with apertures 228 (e.g., slots, windows, etc.) along the cage 208 to couple the distributor 206 to the cage 208.

Referring again to FIG. 7, the cage 208 is configured to secure the pair of valves 202 in position within the interior cavity 111 and to prevent the valve assemblies 200 from separating from the distributors 206. The cage 208 defines a central cavity 229 that is sized to receive the pair of valves 202, a pair of distributors 206, and the flow distribution member 204 therein. In at least one embodiment, the cage 208 includes slots 230 extending from a distal end of the cage 208 that is configured to receive a portion of the water distribution line 104 therein so that the cage 208 straddles the water distribution line 104.

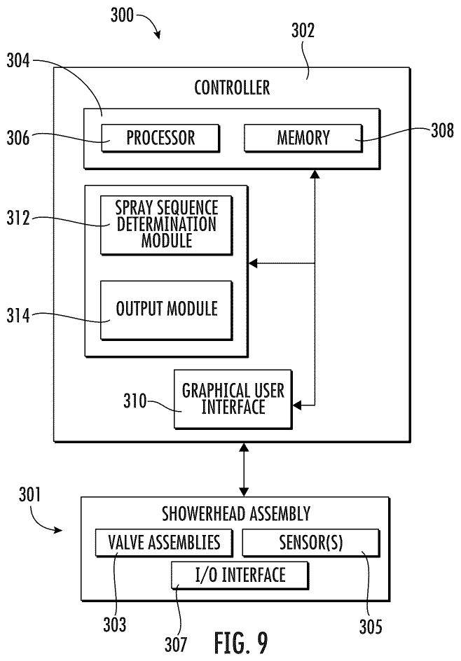

Referring to FIG. 9, a control system 300 that may be used with the showerhead assembly 100 described with reference to FIGS. 1-8 is shown, according to an embodiment. In the embodiment of FIG. 9, the control system 300 is configured to control operation of a showerhead assembly 301 based on user inputs. The showerhead assembly 301 includes a plurality of valve assemblies 303 having at least one electronically controlled valve. The showerhead assembly 301 further includes at least one sensor 305, and an I/O interface 307, as will be further described.

The control system 300 includes a controller 302 that is communicably coupled to the plurality of valve assemblies 200. The controller 302 includes a processing circuit 304 having a processor 306 and memory 308, a graphical user interface (GUI) 310, and a plurality of control modules inclusive of a spray sequence determination module 312 and an output module 314. In other embodiments, the control system 300 may include additional, fewer, and/or different components.

In some embodiments, the processing circuit 304 may be a general purpose or specific purpose processor, an application specific integrated circuit (ASIC), one or more field programmable gate arrays (FPGAs), a group of processing components, or other suitable processing components. The processor 306 is configured to execute computer code or instructions stored in memory 308 or received from other computer readable media (e.g., CDROM, network storage, a remote server, etc.).

Memory 308 may include one or more devices (e.g., memory units, memory devices, storage devices, etc.) for storing data and/or computer code for completing and/or facilitating the various processes described in the present disclosure. Memory 308 may include random access memory (RAM), read-only memory (ROM), hard drive storage, temporary storage, non-volatile memory, flash memory, optical memory, or any other suitable memory for storing software objects and/or computer instructions. Memory 308 may include database components, object code components, script components, or any other type of information structure for supporting the various activities and information structures described in the present disclosure. Memory 308 may be communicably connected to the processor 306 via the processing circuit 304 and may include computer code for executing one or more processes described herein.

The GUI 310 is generated by the controller 302 for display on a human-machine interface that is configured to provide an indication of an operating status and/or control information regarding the showerhead assembly to a user. For example, the GUI 310 may be presented on a user device that is remote from the showerhead assembly (e.g., a cell phone, a tablet, etc.), and/or on a user interface of the showerhead assembly that may be disposed within or adjacent to a shower enclosure. The GUI 310 is also configured to receive and interpret user commands. In some embodiments, as shown in FIG. 8, the GUI 310 is part of the controller 302, such as a software module stored in memory 308 that may be generated by the controller 302 and transmitted to a user device (e.g., a mobile phone, a tablet, a computer, etc.). In other embodiments, the GUI 310 may be part of a software program or mobile application that can be linked to the control system 300 to control operation of the showerhead assembly.

In some embodiments, the GUI 310 includes or forms part of a communications interface for the controller 302, which may include wired or wireless interfaces (e.g., jacks, antennas, transmitters, receivers, transceivers, wire terminals, etc.) for conducting data communications with various systems, devices, or networks. For example, the GUI 310 may include an Ethernet card and port for sending and receiving data via an Ethernet-based communications network. In another example, the GUI 310 may include a Bluetooth transceiver and/or a Wi-Fi transceiver for communicating via a wireless communications network. The GUI 310 may be configured to communicate via local area networks or wide area networks (e.g., the Internet, a building WAN, etc.) and may use a variety of communications protocols (e.g., TCP/IP, point-to-point, etc.). In at least one embodiment, the GUI 310 is configured to communicate with a cloud server (e.g., a third-party server, an internet of things (IoT) server, etc.) and can receive and interpret commands and operating instructions from the cloud server. Such implementations enable control of the showerhead assembly remotely via a user device, such as a smartphone, or any other wired or wireless interface.

In some embodiments, the controller 302 uses the GUI 310 to receive input from various sensors 305 and send control signals to various components, as will be further described.

The controller 302 is configured to control operation of each of the electronically controlled valves within each valve assembly 303 individually using PWM techniques, which can increase the range of spray geometries and experiences that can be produced by the showerhead assembly 301.

In various embodiments, the spray sequence determination module 312 and/or the output module 314 is embodied as software code in memory 308. In other embodiments, the spray sequence determination module 312 and/or the output module 314 are control circuits that are communicably coupled to the processing circuit 304.

The spray sequence determination module 312 is configured to receive and interpret user commands and to determine a spray sequence based on the user commands. In at least one embodiment, the spray sequence includes PWM parameters inclusive of a duty cycle and a frequency of operation for each one of the plurality of electronically controlled valves in each valve assembly 303. In some embodiments, the spray sequence determination module 312 is configured to determine the PWM parameters based on a plurality of spray parameters indicative of a desired spray sequence.

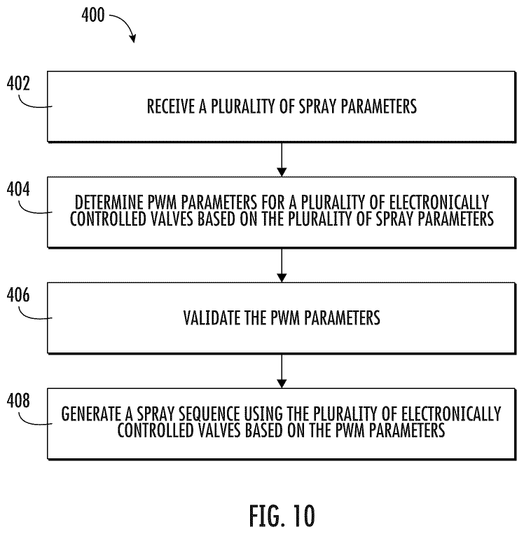

In at least one embodiment, the plurality of spray parameters are parameters associated with a form of a spray pattern as would be observed by a user of the showerhead assembly (e.g., that is observable by a user of the showerhead assembly), instead of raw control parameters for the plurality of electronically controlled valves. For example, Referring to FIG. 10, a method 400 of generating a spray sequence is shown, according to an embodiment. The method 400 may be implemented by the control system 300 of FIG. 9 and, as such, is described with reference to the components shown in FIG. 9.

At 402, the controller 302 (e.g., the spray sequence determination module 312) receives a plurality of spray parameters associated with a form of the spray pattern produced by the showerhead assembly 301. As used herein, the “form of the spray pattern” refers to characteristics of the spray sequence as would be observed by a user during operation of the showerhead assembly. Operation 402 may include receiving a stream length (e.g., an approximate physical length of one continuous stream segment produced by an electronically controlled valve), a time period between streams and/or drops, and/or a flow intensity value (e.g., a value between 1 and 10 that is indicative of a flow rate produced by the showerhead assembly and/or individual ones of the electronically controlled valves). In other embodiments, operation 402 may include receiving another type of spray parameter other than a raw valve control parameter such as valve operating frequency or duty cycle.

Operation 402 may include receiving the plurality of spray parameters from a user via the GUI 310. The GUI 310 is provided to the user, such as via the I/O interface 307, a display, a control panel, etc., and allows the user to select from a wide range of curated, pre-defined spray/pattern sequences a well as generators that output geometric patterns from control algorithms defined by a user and/or stored in memory 308. In some embodiments, the controller 302 is further configured to operation of each of the electronically controlled valves and to identify faults or potential issues to prevent damage to electromechanical systems, as will be further described.

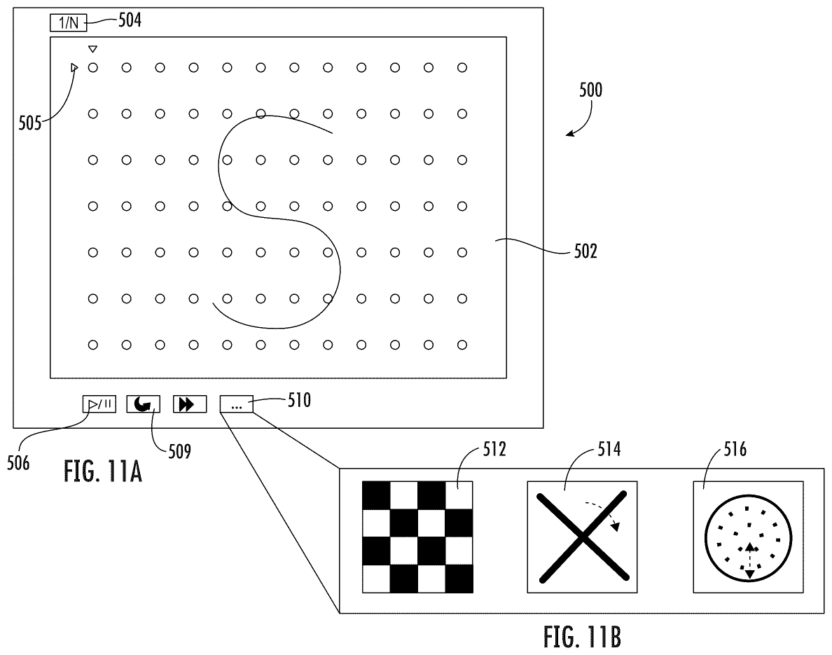

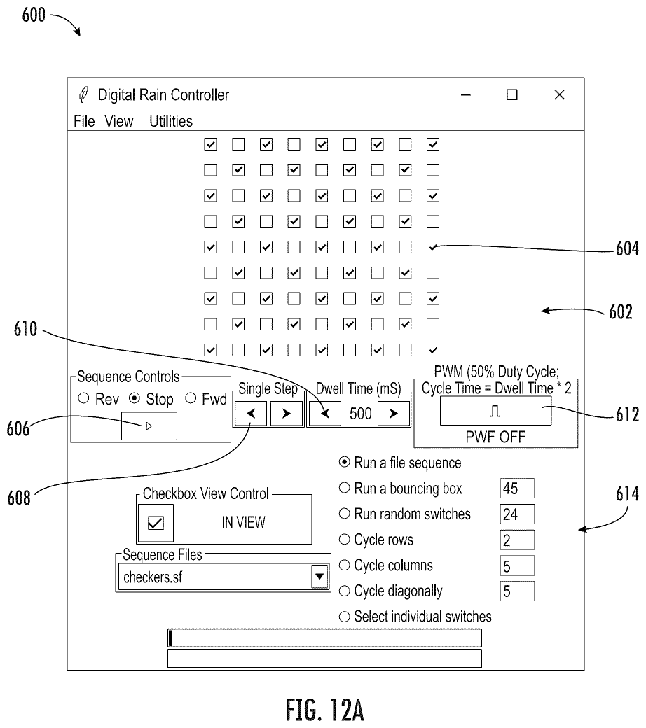

Referring to FIGS. 11A and 11B, an example GUI 500 is shown that is configured to allow a user to input spray parameters into the control system. The GUI 500 includes a graphical solenoid grid 502 displaying graphical representations (e.g., dots, etc.) of each opening along the spray face and/or each one of the electronically controlled valves at a single point in time (i.e., for a single frame 504 of a spray sequence). A user may select any one of the locations along the grid 502 to switch the operating state of the valve within a single frame 504. In some embodiments, the GUI 500 is configured to generate a prompt in response to a selection of one or more locations along the grid 502 (or in response to a separate user command). The prompt includes user-selectable spray parameters that can be used by the controller 302 to determine how to operate any active valves in the current frame 504. In some embodiments, the GUI 500 also includes user-perceptible icons, buttons, etc. (e.g., macro select icons 505) that can be used to select entire rows or columns of openings and/or valves across the showerhead.

In at least one embodiment, the graphical solenoid grid 502 is configured to allow a user to draw shapes, letters and/or patterns to alter the operating state of multiple sets of openings and/or valves. The GUI 500 may be configured to receive user inputs including a dwell time (e.g., a frame period) for each frame 504 (how many frames of a single pattern are run before switching to another spray pattern, etc.), to set an animation speed, and/or to share patterns to other users via a connected device.

In some embodiments, the GUI 500 is configured to display the graphical solenoid grid 502 while the showerhead is running, and the real-time operating state of the openings and/or valves during operation. In this way, a user may be able to make changes to pre-existing spray sequences in memory 308 (e.g., in a frame-by-frame basis, etc.).

In some embodiments, the GUI 500 includes control icons that enable a user to hide the graphical solenoid grid 502 during operation and/or to provide a more simplified set of controls to a user. For example, the GUI 500 may include playback control icons 506 that allow a user to control the speed of the spray sequence in absolute or relative units (e.g., in seconds per sequence, milliseconds per frame 504, ×2 speed, etc.) and/or to pause operation of the spray sequence in certain frames. In some embodiments, the playback control icons 506 are similar to video control icons as shown in FIG. 11A. In the embodiment of FIG. 11A, the GUI 500 further includes a replay icon 509 that allows a user to replay past spray sequences.

In at least one embodiment, the GUI 500 is configured to present predesigned pattern sequences in the form of pattern and/or sequence buttons 510 (see FIG. 11B) that a user can select. The sequences may be presented to a user as a list of two-dimensional (3D) animated patterns that run frame by frame in an endless loop. The controller 302 may be configured to control the valves based on the sequence and to rerun the pattern in an endless loop to provide a continuous shower experience to the user. For example, the predefined pattern sequences may include a checkerboard spray pattern 512 resembling a checkerboard that alternates between inverse patterns of a checkerboard, a fan spray pattern 514 such as a rotating “X” shape or cross, a ripple spray pattern 516 inclusive of a circular or square pattern emanating outward or inward (or outward then inward) from the center of the spray face, a beating heart spray pattern inclusive of a two-frame pattern of a heart shape and its inverse area, a bouncing rectangle or other shape spray pattern inclusive of a bouncing geometric shape resembling a ball bounding within the boundaries of the spray face, or other types of spray patterns.

In some embodiments, the GUI 500 is also configured to allow a user to define a spray sequence or pattern algorithmically based on a mathematical expression. For example, the GUI 500 may include control buttons and/or selectable representations of the showerhead that allow a user to: (i) draw each individual frame by selecting which solenoid valves in the grid will be open or closed; (ii) set a dwell time for each frame/pattern (e.g., how many frames before switching to another pattern); (iii) set a default animation speed; (iv) start from scratch or select from premade/user or manufacturer defined patterns as a starting point; and (v) share patterns to other users via connected device(s).

In some embodiments, the GUI 500 is also configured to present three-dimensional (3D) animated patterns to the user. The 3D patterns may be configured to control both the 2D flow area as well as changes in flow rate, intensity, etc. along the axial direction (the axial direction extending away from the faceplate of the showerhead). In some embodiments, the 3D patterns are rendered via rapid firing 2D transverse sections of the whole (in different areas along the spray face). The 3D patterns may be selected from a predefined list, a lookup table in memory, or using images that present a visual indication of the spray pattern to a user. The controller 302 may be configured to control the density or opacity of the resulting object in water form by one, or a combination of: (i) multiplying a quantity of each transverse section by a constant and increasing a framerate of the sequence (e.g., in a similar manner as decreasing the line-spacing of a many-lined document until an ASCII art image appears from the text) producing multiple copies in each transverse section to make the resulting section darker when observed at speed; (ii) selectively removing or inserting empty or partially filled transverse sections where a solid section once was; (iii) changing a framerate of the sequence; and/or (iv) manipulating frequency and duty cycle (PWM) of the solenoid valves independent of a framerate of the sequence (e.g., where the PWM frequency is greater than the framerate, controlling the sequence so that the frame's pattern is repeated multiple times before the end of a period of the frame).

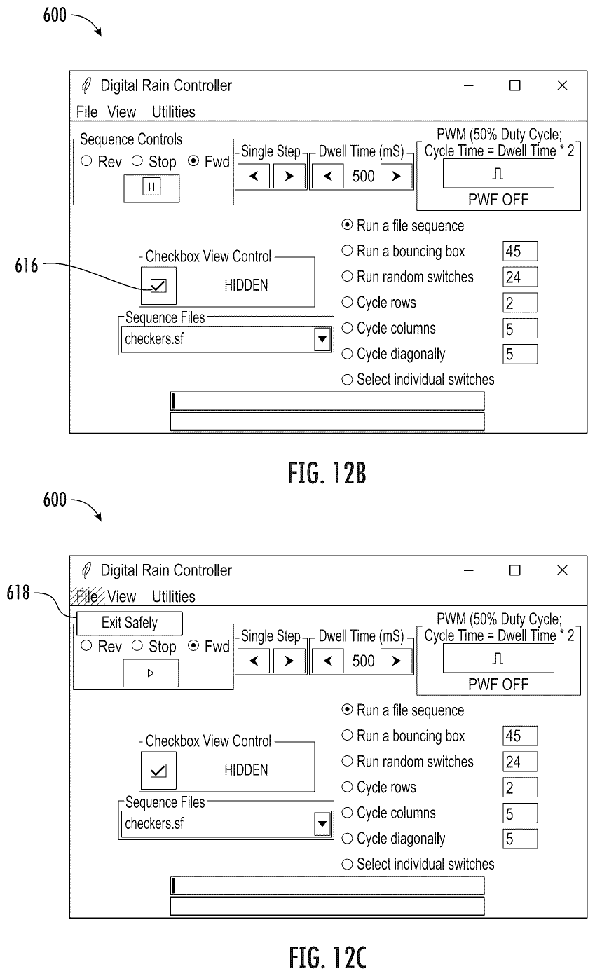

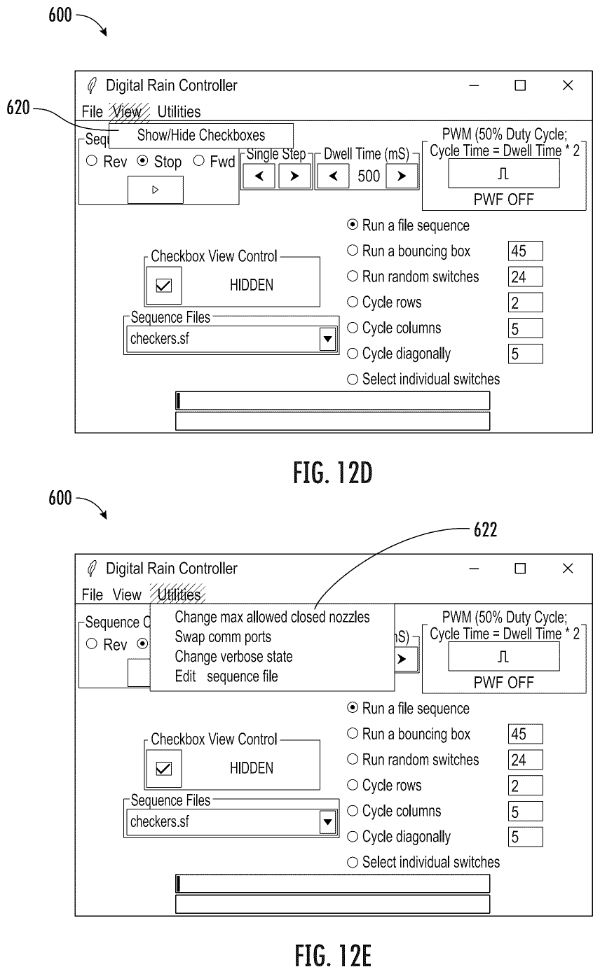

Referring to FIGS. 12A-12E, another embodiment of a GUI 600 for a showerhead assembly is shown. The GUI 600 includes a graphical solenoid grid 602 displaying graphical representations of each one of the electronically controlled valves along the spray face at a single point in time (for a single frame). In the embodiment of FIG. 12A, the graphical solenoid grid 602 includes checkbox indicators 604 for each of the valves across the spray face. A user can select individual ones of the checkbox indicators 604 to set a spray pattern within a single frame. In some embodiments, the checkbox indicators 604 also provide an indication of the two-dimensional spray pattern that corresponds with a single frame of a selected sequence. For example, in the embodiment of FIG. 12A, a checker box (e.g., checkers, etc.) sequence has been selected and the corresponding two-dimensional spray pattern in a single frame indicated with check marks in alternating ones of the checkbox indicators 604.

The GUI 600 provides user selectable icons (e.g., playback control icons 606 as described with reference to FIG. 11A; frame select icons 608 configured to allow a user to step between individual frames of a sequence; a dwell time control icon 610 configured to allow a user to adjust a dwell time for each frame during a sequence; a PWM activation icon 612 configured to control activation/deactivation of PWM functionality to conserve water; and a sequence selection panel 614 configured to allow a user to select different sequences from memory and/or from external storage). In other embodiments, the GUI 600 may include additional, fewer, and/or different icons.

Referring to FIGS. 12B and 12C, the GUI 600 may also include a view control icon 616 that allows a user to hide the graphical solenoid grid 602 from view. The GUI 600 may also include a safe exit icon 618 or dropdown file save option that enables a user to exit the GUI 600 and return the showerhead to a user-defined control state (e.g., sequence) based on user selections in the GUI 600 (and exiting any intermediate operating states, or operating states at individual frames). In some embodiments, selecting the safe exit icon 618 saves the user selections to memory and deactivates the showerhead in preparation for future use.

Referring to FIGS. 12D and 12E, the GUI 600 may also include various dropdown windows that enable modification of GUI 600 settings. For example, the GUI 600 may include a view window 620 that provides a user with a list of selectable view modes (e.g., to change viewing states of the GUI 600). In some embodiments, the GUI 600 includes a utilities window 622 that provides a user with a list of operational settings and/or to access diagnostics and/or settings for the showerhead. The utilities window 622 may also provide an option to edit a sequence file in memory or to access sequence files from external storage (e.g., a universal serial bus (USB) drive, etc.) or from the Internet, Bluetooth®, and/or or a cloud server.

Referring again to FIG. 10, at operation 404, the controller 302 (e.g., the spray sequence determination module 312) determines the PWM parameter(s) based on at least one of the plurality of spray parameters. Operation 404 may include determining an operating frequency and a duty cycle of at least one of the electronically controlled valves based on the spray parameter(s). For example, the controller 302 may be configured to iterate through a lookup table stored in memory 308 to determine the PWM parameter(s) as a function of the spray parameter(s), or by using an algorithm (e.g., an empirical algorithm) to determine valve frequency and/or duty cycle based on the spray parameter(s). In some embodiments, the lookup table and/or algorithm may be determined experimentally based on test data to determine spray patterns and/or geometries that correspond with different PWM parameters.

At 406, the controller 302 (e.g., the spray sequence determination module 312, the output module 314, etc.) validates the PWM parameters. In some embodiments, operation 406 includes determining (e.g., calculating) a flow rate throughout the spray sequence to ensure that the fluid flow rate satisfies (e.g., is greater than, less than, approximately equal to, within a threshold range of, etc.) at least one of a first threshold flow rate (e.g., a lower threshold flow rate, a minimum flow rate, etc.) and a second threshold flow rate (e.g., an upper threshold flow rate, a maximum flow rate, etc.). Operation 406 may include modifying a number of active valves, or the PWM parameters, based on the validation process, and to prevent significant changes in flow rate or performance outside of a prescribed operating range for the showerhead assembly. For example, operation 406 may include modifying the number of active valves to ensure that an overall flow rate produced by the showerhead assembly is between the lower threshold flow rate and the upper threshold flow rate.

At 408, the controller 302 (e.g., the output module 314) generates a spray sequence using the plurality of electronically controlled valves based on the PWM parameters. Operation 408 may include sending a command signal to each of the plurality of electronically controlled valves to control operation of the valves throughout the spray sequence. For example, operation 408 may include generating an activation profile for each of the valves based on the PWM parameters and transmitting a voltage signal corresponding with the activation profile to the valves.

Referring again to FIG. 9, in at least one embodiment, the spray sequence determination module 312 is configured to determine the spray sequence based on data from at least one sensor 305, which may be separate from, or form part of, the showerhead assembly 301 in various embodiments. For example, the sensor(s) 303 may include an optical sensor such as a motion detector or camera. In such embodiments, the sensor(s) 303 may be configured to provide sensor data indicative of a position of a user relative to (e.g., beneath, in front of, etc.) the showerhead assembly 301. The spray sequence determination module 312 may be configured to determine the position of the user based on the sensor data and a command signal to control the spray sequence based on the position. For example, the spray sequence determination module 312 may be configured to determine which of the electronically controlled valves to active to maintain a spray of water over the user based on the position of the user relative to the showerhead assembly.

In some embodiments, the spray sequence determination module 312 is configured to determine a user's hand or body gestures based on data received from the sensor(s) 303 and to determine the spray sequence that corresponds with the gestures. For example, the spray sequence determination module 312 may use machine-learning techniques (artificial intelligence) to determine gesture(s) based on sensor data. The spray sequence determination module 312 may be configured to determine the spray sequence by accessing a lookup table in memory 308 and by iterating through the lookup table to identify the spray sequence that corresponds with the gesture(s).

The spray sequence determination module 312 may also be configured to control the showerhead assembly based on other sensed parameters. In at least one embodiment, the spray sequence determination module 312 is configured to adaptively control the spray sequence based on at least one of: (i) a water flow rate upstream of the showerhead assembly and/or (ii) a water pressure upstream of the showerhead assembly. For example, in one embodiment, the sensor(s) 305 include a flow meter that is disposed at an inlet to the showerhead assembly (e.g., an inlet to the water distribution loop, etc.). In such embodiments, the spray sequence determination module 312 may be configured to adaptively control the spray sequence (e.g., a spray routine, a number of open valves, a spray geometry, a duty cycle, a frequency, etc.) based on a comparison between the measured flow rate and at least one threshold value stored in memory 308. Such an approach can also be used to maintain flow rates through the showerhead assembly to below a user-specified threshold value (e.g., below 2.5 gallons per minute, 2.0 gallons per minute, 1.75 gallons per minute, or another limit based on jurisdictional requirements and/or user preferences).

In some embodiments, the spray sequence determination module 312 is also configured to monitor valve operating parameters of each of the plurality of electronically controlled values (e.g., the real-time frequency and duty cycle of the PWM control sequence), and to determine and store a real-time and/or a historical water usage based on the valve operating parameters. The stored water usage data can be shared with a user (e.g., via the GUI 310 and/or the I/O interface 307) to improve their understanding of how different spray sequences affect water usage. In some embodiments, the GUI 310 is also configured to enable viewing of water usage data on an individual valve level, which can facilitate fault monitoring. In some embodiments, the spray sequence determination module 312 is configured to identify faulty and/or damaged valves based on the water usage data. For example, spray sequence determination module 312 may be configured to compare water usage of the individual valves to an average water usage value across the valves, or to threshold operating values stored in memory 308.

In at least one embodiment, the control system 300 includes a secondary user interface disposed on the showerhead assembly 301, and/or a control panel that is separate from the showerhead assembly 301, to convey information to a user. The secondary user interface may include a display, a speaker, or another type of human-machine interface. Referring again to FIGS. 1 and 2, in some embodiments, the secondary user interface includes an indicator panel 132 disposed along the sidewalls 110 of the housing 102. The indicator panel 132 is an illuminated banner that extends along a perimeter (e.g., an outside bezel) of the housing 102 and is configured to illuminate at least a portion of the environment surrounding the showerhead assembly 100. The indicator panel 132 may be controlled to generate a chromatherapy (e.g., color therapy) light ring that changes color or provides white task light, or a border of organic light-emitting diode (OLED) display. In other embodiments, a border of the housing 102 could have an electroplated escutcheon of various finishes, which can improve the overall aesthetic of the device. Other secondary user interfaces can be used with or incorporated into the showerhead assembly 100 in various embodiments. For example, in some embodiments, the showerhead assembly 100 includes lights (e.g., LEDs, etc.) disposed on the front plate 104 or in any other location along the housing 102. In some embodiments, the showerhead assembly 100 further includes an infrared light that is configured to heat a portion of the shower enclosure. In yet further embodiments, the showerhead assembly includes fiber optic light pipes for each of the distributors and/or nozzles that enable generation of different color patterns that may be coordinated with flow sequences generated by the showerhead assembly.

In some embodiments, the spray sequence determination module 312 is configured to coordinate operation of the secondary user interface with the spray sequence. For example, the spray sequence determination module 312 may be configured to control at least one of: light color, light pattern and/or sounds based on the spray sequence, such as by generating lights that follow a direction of the spray pattern produced by the showerhead, and/or sounds that correspond with various spray sequences. Such an arrangement can enhance the overall showering experience.

The output module 314 is configured to control operation of each one of the plurality of electronically controlled valves based on information from the spray sequence determination module 312. In some embodiments, the output module 314 is configured to transmit a control signal to each of the plurality of electronically controlled valves individually, as described with reference to the method 400 of FIG. 10.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the application as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the apparatus and control system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments.

Other substitutions, modifications, changes and omissions may also be made in the design, operating conditions and arrangement of the various exemplary embodiments without departing from the scope of the present application. For example, any element disclosed in one embodiment may be incorporated or utilized with any other embodiment disclosed herein.

What is claimed is:

1. A showerhead assembly comprising:
a housing defining an interior cavity and a spray face, the spray face defining a plurality of openings;
a water distribution line disposed within the interior cavity; and
a plurality of electronically controlled valves disposed within the interior cavity and fluidly coupled to the water distribution line, the plurality of electronically controlled valves distributed across the interior cavity and configured to control a flow of water passing through the plurality of openings.

2. The showerhead assembly of claim 1, wherein the plurality of electronically controlled valves are normally-open direct acting valves that are controllable using pulse-width modulation techniques.

3. The showerhead assembly of claim 1, further comprising a plurality of distributors coupled to the plurality of electronically controlled valves, at least one of the plurality of distributors fluidly coupling a respective valve of the plurality of electronically controlled valves to at least two of the plurality of openings.

4. The showerhead assembly of claim 1, wherein at least two valves of the plurality of electronically controlled valves together form part of a valve assembly, the valve assembly further including:
a flow splitter fluidly coupling the at least two valves to the water distribution line;
a distributor fluidly coupling a respective one of the at least two valves to at least one opening of the plurality of openings; and
a cage enclosing the flow splitter and the at least two valves.

5. The showerhead assembly of claim 1, wherein the water distribution line is a pressurized water distribution line that is configured to be directly fluidly coupled to a residential water supply line providing water at residential water supply pressures.

6. The showerhead assembly of claim 1, wherein the water distribution line includes a plurality of supply conduits and a plurality of bridge connections that fluidly couple adjacent ones of the plurality of supply conduits, the plurality of supply conduits and the plurality of bridge connections disposed within the interior cavity.

7. The showerhead assembly of claim 1, wherein the water distribution line is configured to substantially prevent leakage of water into the interior cavity.

8. The showerhead assembly of claim 1, wherein the housing comprises a front plate that defines the spray face, the showerhead assembly further comprising a support structure disposed within the interior cavity, the support structure supporting the water distribution line a distance apart from the front plate.

9. The showerhead assembly of claim 1, wherein the housing comprises a front plate that defines the spray face, the water distribution line extending across the front plate within the interior cavity.

10. The showerhead assembly of claim 1, further comprising a controller communicably coupled to the plurality of electronically controlled valves, the controller configured to:
receive a user input inclusive of a plurality of spray parameters associated with a form of a spray pattern; and
determine a plurality of pulse width modulation parameters for the plurality of electronically controlled valves based on the plurality of spray parameters.

11. A showerhead assembly comprising:
a housing defining an interior cavity and a spray face, the spray face defining a plurality of openings; and
a plurality of valve assemblies coupled to the housing, at least one valve assembly of the plurality of valve assemblies comprising:
a plurality of electronically controlled valves configured to control a flow of water passing through the plurality of openings;
a flow splitter coupled to the plurality of electronically controlled valves and configured to distribute flow between the plurality of electronically controlled valves; and
a distributor coupled to at least one of the plurality of electronically controlled valves and engaging at least one opening of the plurality of openings.

12. The showerhead assembly of claim 11, wherein the distributor is coupled to an individual valve of the plurality of electronically controlled valves, and wherein the distributor is configured to distribute flow from the individual valve to at least two of the plurality of openings.

13. The showerhead assembly of claim 11, wherein the distributor engages at least two of the plurality of openings.

14. The showerhead assembly of claim 11, wherein the at least one valve assembly further comprises a cage enclosing at least a portion of the flow splitter and at least a portion of the plurality of electronically controlled valves.

15. The showerhead assembly of claim 11, further comprising a controller communicably coupled to the plurality of electronically controlled valves, the controller configured to:
receive a user input inclusive of a plurality of spray parameters associated with a form of a spray pattern; and
determine a plurality of pulse width modulation parameters for the plurality of electronically controlled valves based on the plurality of spray parameters.

16. A control system for a showerhead assembly, comprising:
a plurality of electronically controlled valves;
a user interface; and
a controller communicably coupled to the plurality of electronically controlled valves and the user interface, the controller configured to:
receive a user input from the user interface inclusive of a plurality of spray parameters associated with a form of a spray pattern that is observable by a user of a showerhead assembly;
determine a plurality of pulse width modulation (PWM) parameters for the plurality of electronically controlled valves based on the plurality of spray parameters; and
control the plurality of electronically controlled valves passed on the plurality of PWM parameters.

17. The control system of claim 16, wherein the plurality of spray parameters includes a stream length, a time period between streams and/or drops, and/or a flow intensity value.

18. The control system of claim 16, wherein the plurality of PWM parameters comprises a frequency and/or a duty cycle of the plurality of electronically controlled valves.

19. The control system of claim 16, wherein the controller is further configured to modify a number of active ones of the plurality of electronically controlled valves to ensure that an overall flow rate produced by the plurality of electronically controlled valves satisfies a lower threshold flow rate and an upper threshold flow rate.

20. The control system of claim 16, wherein the controller is further configured to generate a spray sequence using the plurality of electronically controlled valves based on the plurality of PWM parameters.
